(19) United States
(12) Patent Application Publication
(10) Pub. No.: US 2006/0173784 A1
(43) Pub. Date: Aug. 3, 2006

(54) Payment system for the distribution of digital content using an intelligent services control point

(76) Inventors: David J. Marples, Mansfield (GB); Benjamin W. Falchuk, Upper Nyack, NY (US)

Correspondence Address: TELCORDIA TECHNOLOGIES, INC., ONE TELCORDIA DRIVE 5G116, PISCATAWAY, NJ, 08854-4157, US

(21) Appl. No.: 11/341,227

(22) Filed: Jan. 26, 2006

Related U.S. Application Data
(60) Provisional application No. 60/647,045, filed on Jan. 26, 2005.

(51) Int. Cl. G06Q 99/00

(52) U.S. Cl. 705/52

(57) ABSTRACT

A payment system for a digital content distribution system uses a Digital Rights Management (DRM) Controller that inquires through and accounting and content web server whether the user requesting the transfer of content has sufficient funds. Upon receiving information about the balance of the account associated with the receiving user and determining that the account has sufficient funds the transfer is permitted. The DRM Controller sends an encryption key and hash to the user sending the digital content. The encrypted digital content is transferred in a peer-to-peer manner so that the DRM Controller never possesses the actual content. The DRM Controller initiates billing for payment after the transfer by sending a message requesting a debit of the receiver's account stored in an intelligent services control point. The intelligent services control point provides a scalable platform for billing for minute amounts without incurring additional cost.

### CROSS REFERENCE TO RELATED APPLICATION

This application claims the benefit of priority of U.S. Provisional Patent Application No. 60/647,045 filed on Jan. 26, 2005, entitled “Payment System For Digital Content Delivery Using An Intelligent Services Control Point (ISCP)”. This application is related to U.S. patent application Ser. No. ______ (APP1593) entitled “System and Method for Authorized Digital Content Distribution” filed concurrently herewith.

### FIELD OF THE INVENTION

The present invention relates generally to the field of digital content distribution in a telecommunications network and, more specifically, to the field of billing for the authorized distribution of digital content in peer-to-peer networks.

### BACKGROUND

The distribution of digital content in a legitimate manner has been made more difficult by the lack of a cost-effective solution for paying for content, particularly content distributed in a peer-to-peer (P2P) network environment. Many users of digital content such as digital music files or digital movie or video files would pay for such content. Often, however, the cost of setting up a centralized system to permit the downloading of and payment for digital content is cost-prohibitive and would require users to pay more than they are willing. The Apple iTunes system has been a successful entrant in the centralized model of digital content distribution, but this model does not work unless the volume of downloads per user and in the aggregate can cover the cost of such a centralized system. Even the Apple iTunes system may not be sufficiently inexpensive to enable distribution of digital content at a low enough price for example for unknown artists. Additionally, much of the digital content being distributed today is done in a P2P network rather than centralized systems such as the Apple iTunes system.

Peer-to-peer (P2P) networks are networks that enable a computer user in possession of digital content to share the digital content with other users without having to transfer to or download the content from a central server. Many P2P networks have been used to distribute digital content without the consent of the owner of the copyright in the digital content. Many of these P2P networks have been attacked in the courts and have been shut-down or their use limited to works in the public domain or for which permission for unlimited, uncompensated distribution has been granted.

Current digital rights management (DRM) solutions tend to have originated with rights holders and thus tend to enforce additional restrictions on the use of purchased materials above and beyond those which consumers have come to expect with videocassette recorders (VCRs) and the Compact Cassette. This has lead to consumer resentment. DRM solutions also tend to be somewhat centralized in nature leading to limited, or very expensive solution.

One industry that has developed specialized expertise in the billing of small amounts for specific transactions in a network is the wireline and wireless telecommunications industry. An Advance Intelligent Network (AIN) is a telephone network architecture that allows the separation of service logic (i.e., the software controlling and billing for a specific service) from the switching equipment that ultimately performs the service. Thus, AIN enable new services to be defined without redesigning the underlying switching network.

An intelligent Service Control Point (SCP) is a key part of an AIN that contains the intelligence for service creation, management and routing. One example is the Telcordia® ISCP® system which is a flexible, configurable, high-performance, carrier-grade platform for creating and deploying enhanced services in circuit-switched, packet, mobile or cable networks.

Thus, there is a need for a payment system that could be used to enable a user receiving digital content to pay for such digital content in a cost-effective manner particularly where the content is distributed in a P2P distribution scheme

It would be desirable to have a digital content payment system that that can enable charging back to a prepaid account such as an existing prepaid mobile phone account.

Furthermore, it would be desirable to have a digital content payment system that is flexible, extensible and can be integrated with existing PSP distribution systems.

Additionally, it would be desirable to have a digital content payment system that supports audit trails on content exchanges in order to track the distribution of content to the content rights holder.

Furthermore, it would be desirable to have a digital content payment system that is secure in its implementation.

Furthermore, it would be desirable to enable legal, auditable digital content exchange on an operator's network by situating only very limited new logic into best-of-breed SCP software and hardware infrastructure that they already manage.

Furthermore, it would be desirable to gain revenues from legal digital content distribution via a software system that does not depend on storage or management of the actual digital content. i.e. it keeps content storage disparate from content distribution transaction management.

Furthermore, for a telecommunications operator, it would be desirable that the same software system (e.g. SCP suite) that handles voice transactions would also handle the peer to peer digital content exchange transactions.

Finally, it would be desirable to have a robust, scalable network based payment system that manages file swaps, payments and record keeping.

### SUMMARY

The present invention enables the receiver of digital content distributed within a legal framework to pay for the digital content using existing pre-paid telecommunications services account managed at an intelligent services control point. Two sharing users, A and B, previously registered with a digital rights management (DRM) controller, find by some arbitrary method that they wish to exchange a piece of digital content, X. B requests a copy of digital content X from A, which A is willing to provide and so A sends an acknowledgement back to B. Both A and B register their interest in the content element X with a digital rights management (DRM) Controller.

The DRM Controller performs a set of arbitrary tests including querying the pre-pay account of the user through an accounting and web services platform. The accounting and web services platform (DRMP) sends a query via the ISA to the ISCP. The DRM Controller allows the transaction to proceeds if there are sufficient funds. After the transaction The DRM Controller also sends a message to the accounting and web-services platform to “register file X to User B”. DRM Controller also sends a message to the accounting platform to debit the receiving user's account by a certain transaction amount. The accounting and web-services platform sends a message to the SCP using the ISA to debit B's account. The transaction is logged to the DRS system. DRM Controller also sends a message to the accounting and web services platform to credit the sending users account by the transaction amount. The accounting and web-services platform then sends a message to the SCP using the ISA to credit User A's account by the transaction amount. The SCP then logs the credit transaction to the DRS System.

User A encrypts the content using they key provided by the DRM controller and then calculates a hash over the encrypted form of the content E(X) returning this value to the DRM Controller. Because encryption key, E, is not known ahead of time, user A cannot know the value of the hash a priori and can only calculate it by performing the Encryption/Hash Calculation steps. On checking the returned hash against the hash from the table the DRM controller knows that User A does indeed have the content element X and it is in good condition. The DRM Controller then instructs both A and B that the transfer may proceed.

The encrypted form of the content E(X) is transferred from user A to user B by arbitrary means that are well known in the art. Once the content transfer has completed B ensures that the received content has been physically written to non-volatile storage (to account for crashes etc. during the next step). B then calculates a hash over the received content and returns this value to the DRM Controller. If this value matches the value previously given then the transfer has been successful and the DRM Controller updates whatever central records are appropriate, while also returning a decrypt key to B to allow it to decrypt the content. A record of the transfer is kept for a period of time such that if B crashed in the period from obtaining the complete content to receiving the decrypt key and decrypting the content then B could request said key again without incurring additional charges.

Pursuant to the transfer from user A to user B a command is sent to an intelligent services control point (SCP) that then decrements the account of the receiver of the digital content, user B and increments the account of user A and/or the account of the owner of the digital content. The owner of the digital content has registered the digital content with the system and stored a series of encryption keys and hashes so as to enable the system to function.

It will be noted that the DRM Controller never needed to ‘see’ the content. It only requires a set of encrypt key/hash pairs. If these pairs are generated by an external responsible authority then the organization running the DRM Controller need never see or have knowledge of what the content element is. Note that in an extension to the invention if the key/hash pairs are consumed this would serve as a form of audit and tracking for the content rights holder and would also prevent possible attacks based in the re-use of key/hash pairs

Note that since the Controller and other components are triggered during distribution “mediation” phase, they are almost independent of the peer-to-peer client tool which calls them. Most popular P2P client search capabilities could be used to find content of interest. Then, with only minimal changes to that client (or, some event-based event interception technique) the transaction can be mediated by the present invention.

It will be noted that the present invention's ubiquitous Web Services interfaces (notably those that process Simple Object Access Protocol (SOAP) messages) makes its insertion into an operator's infrastructure no more difficult that extending today's Service Oriented Architecture (SOA) systems.

Note that simple variations on how the present invention handles mediation of content allows the Invention to support so-called P2P “swarming” paradigms in which content arrives to a user's device upon request but instead of arriving from a single source on the network it may arrive in “chunks” from 2 or more sources. Once all chunks are received, duplicates may be eliminated, they are ordered properly, and the original content is reassembled.

It should be noted that the present invention's mechanisms allow any number of different compensation and payment models. For example, not only can an SCP handle account debits but it can also perform credits. Therefore, the possibility of micro-credits for users that “forward-distribute” content (i.e. make it available for distribution—one way to do this is through user-interactions with the Content Registry Web Service 140a.

### BRIEF DESCRIPTION OF THE DRAWINGS

FIG. 1 depicts the architecture of one embodiment of a digital content distribution system in accordance with the present invention;

FIG. 2 depicts the architecture of another embodiment of a digital content distribution system in accordance with the present invention;

FIG. 3 depicts the graphical user interface for use of users of the file sharing process of a digital content distribution system in accordance with the present invention;

FIG. 4 depicts the process flow of the file sharing process in a digital content distribution system in accordance with the present invention;

FIG. 5 depicts an example of the content shared in a digital content distribution system in accordance with the present invention; and,

FIGS. 6A-E depict the graphical user interface screens forming the interface to the DRM self-service web-site in a digital content distribution system in accordance with the present invention.

FIG. 7 is a flow diagram depicting the flow of messages in a payment transaction system in accordance with the present invention.

### DETAILED DESCRIPTION OF THE DRAWINGS

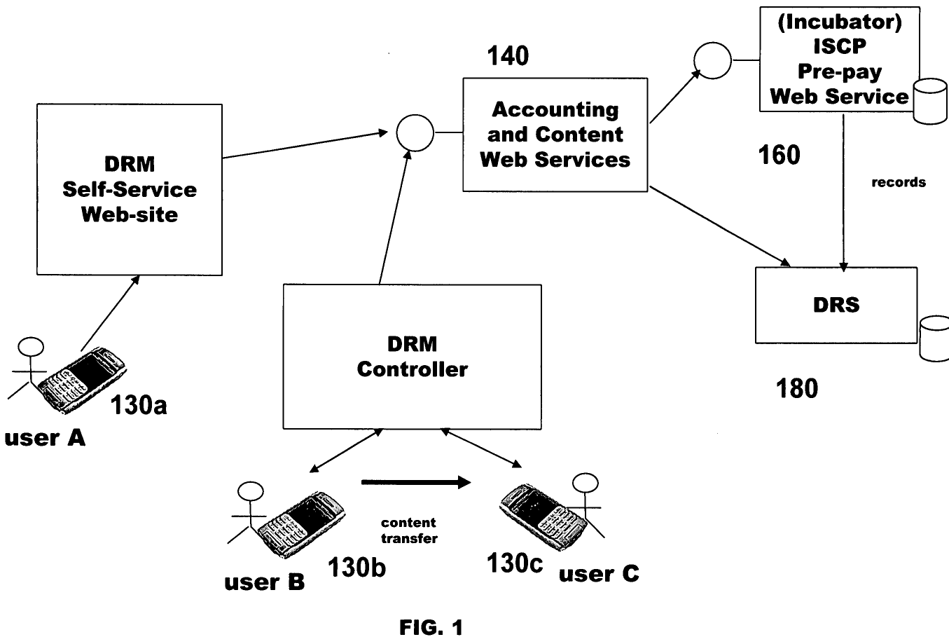

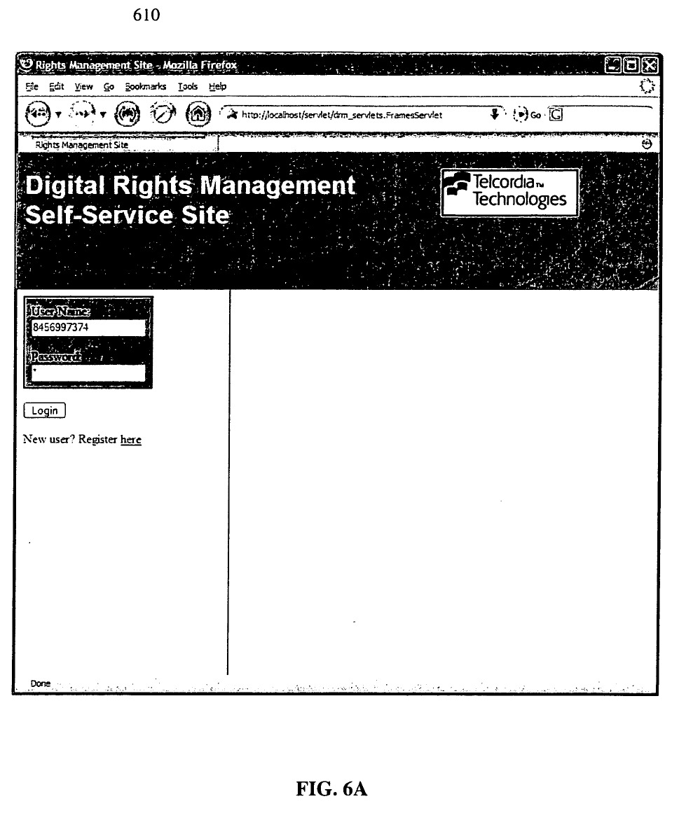

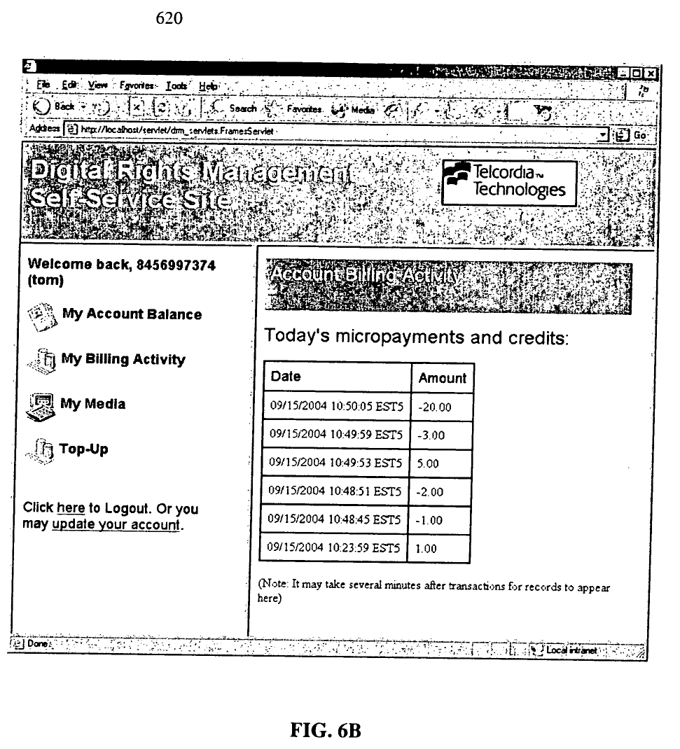

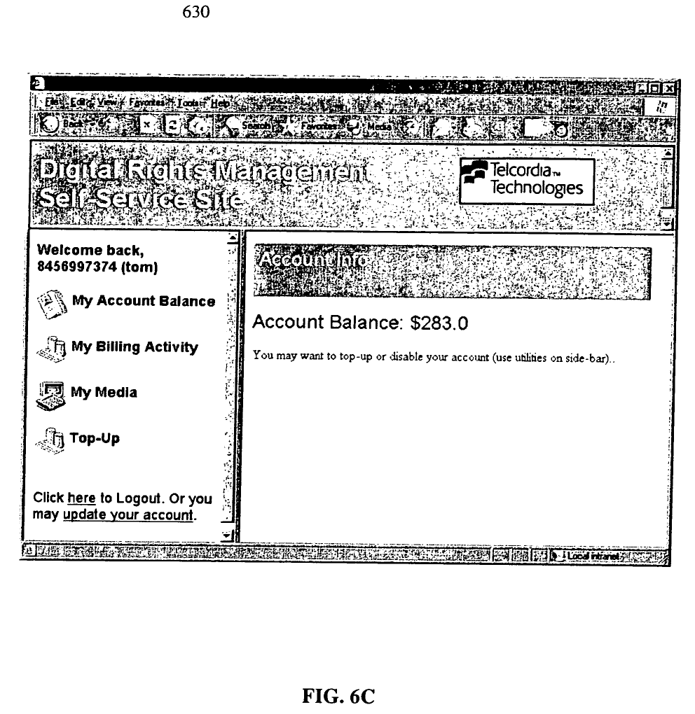

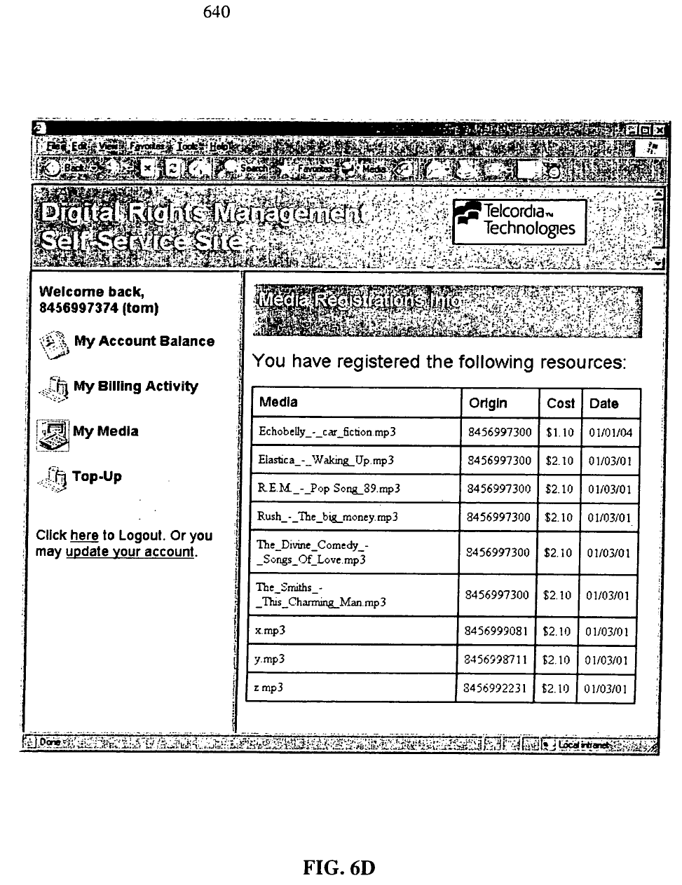

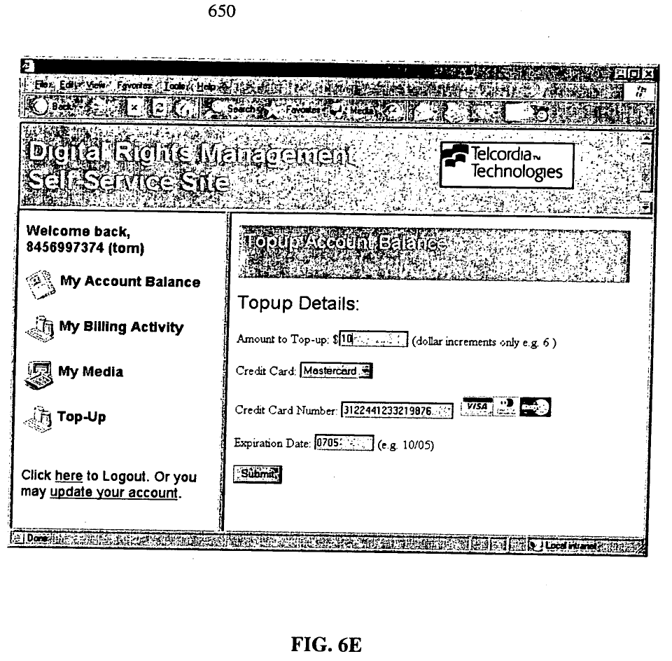

In FIG. 1 the architecture of a digital content distribution system integrated with the pre-payment system of the present invention is shown. User A communicates with a DRM Self-Service Web-Site 100 using a device 130a for the purpose of inputting various information regarding the distribution of content owned or controlled by User A. Device 130a may be any type of general purpose personal computer (PC), personal digital assistant (PDA), mobile handset, cellular telephone or other handheld device capable of communicating in a wired or wireless manner with the Internet so as to display one or more user input screen such as those discusses below in relation to FIG. 6. Device 130a would need software such as an Internet browser, Wireless Access Protocol (WAP) browser or other similar software in order to send and receive data from the DRM Self-Service Web-Site 100. This type of software is well-known in the art.

User A communicates using device 130a with DRM Self-Service Web-Site 100 in order to specify various parameters with respect to the transfer of content between one or more other users such as User B and User C. FIG. 1 shows the arrangement of components within a typical operational digital content distribution system. In this example, transfer of digital content owned or controlled by User A is transferred between User B and User C using the associated DRM Controller 120. The other components are important for the construction of a physical system but are not as important to the present invention as DRM Controller 120.

DRM Controller 120 communicated with DRM Self-Service Web-Site 100 in order to receive information regarding how to handle a transfer of digital content from one user to another, such as the transfer of digital content from User B to User C. User B and User C communicate with DRM Controller 120 and with each other by using devices 130b and 130c which devices are similarly enabled to device 130a described above. A typical transaction would begin with some type of dialog between User B and User C that leads the two to decide that one has content that it would like to share with the other.

Accounting and Content Web (ACW) Server (also referred to as the DRMP) 140 comprises software implemented on a general purpose computer that is capable of keeping track of transfer of digital content and payment of digital content. ACW Server 140 is in communication with DRM Self-Service Web-Site 100 in order to receive information about the amount of compensation a user such as User A desires to receive for transfers of digital content between other user such as User B and User C.

The present invention is depicted in the following components of FIG. 1. ACW Server 140 is also in communication with SCP Pre-Pay Web Service Server 160 that is an (intelligent) service control point capable of decrementing an account of the user paying for a transfer of content and incrementing one or more of the accounts of the user transferring content and/or the owner of the content being transferred. In this way, P2P transfers of digital content can be accomplished with the knowledge and approval of the owner of the content who is properly compensated for the transfer. SCP Pre-Pay Server 160 is in communication with the Data and Reports System (DRS) 180 which is a repository of records associated with the transfer of digital content and payment for such transfers.

The payment system of the present invention comprises a transaction engine, the SCP Pre-Pay Server 160 that is connected to the ACW Server 140. In the SCP Pre-Pay Server 160 a service environment provides for the provisioning and execution of the distribution and payment services, an SS7 Adaptator provides telephony call setup, routing and control and a web server provides an interface to CSP (pre-pay and other) functionality for clients via well-known Web Services protocols such as Simple Object Access Protocol. Additionally, a Session Initation Protocol Front End provides access to SCP functionality 160 via the Session Initiation Protocol (SIP).

The intelligent SCP Services Access (ISA) API enables client applications such as the ACW Server 140 to access service logic in the SCP Pre-Pay Sever 160. This API provides extensible, flexible capabilites such as direct update of ISCP subscription data related to prepaid accounts, access to subscription data on other network elements such as the Home Location Regiter (HLR). In addition to how it is already used in the AIN, the transaction engine in the SCP Pre-Pay Server is in communication with the ACW Server 140 via the ISA interface. For example, before a sharing of digital content from User B to User C, a series of calls to the SCP through the ISA determines if User C has sufficient funds in his or her prepaid account to cover the costs. The ACW Server 140 uses a “getBalance” command to retrieve the account balance of the user requesting a transfer. An “updateBalance” commence is used to update a subscribers balance when a debit or credit is required. A debit would be required if the user is paying for content received. A credit would be required if the user is receiving payment for transferring content either as the owner of the content or as an intermediary. A “getbillingActivity” command is used to retrieve the billing activity of a user for a specific time-frame and can be used both for administration and subscriber self-management. The DRS has detailed account activity and will respond to a query forwarded by the SCP Pre-Pay Sever 160.

The DRS 180 gathers reports on network data generated by various components of the SCP Pre-Pay Server 160, including customized call sample data, node measurements, special study data, customer measurement data and application measurements. Detailed call and SMS information is captured an send to DRS 180 SCP Pre-Pay Sever 160 can be any of several known intelligent service control points such as the Telcordia Converged Application Sever and/or Real-Time Charging System.

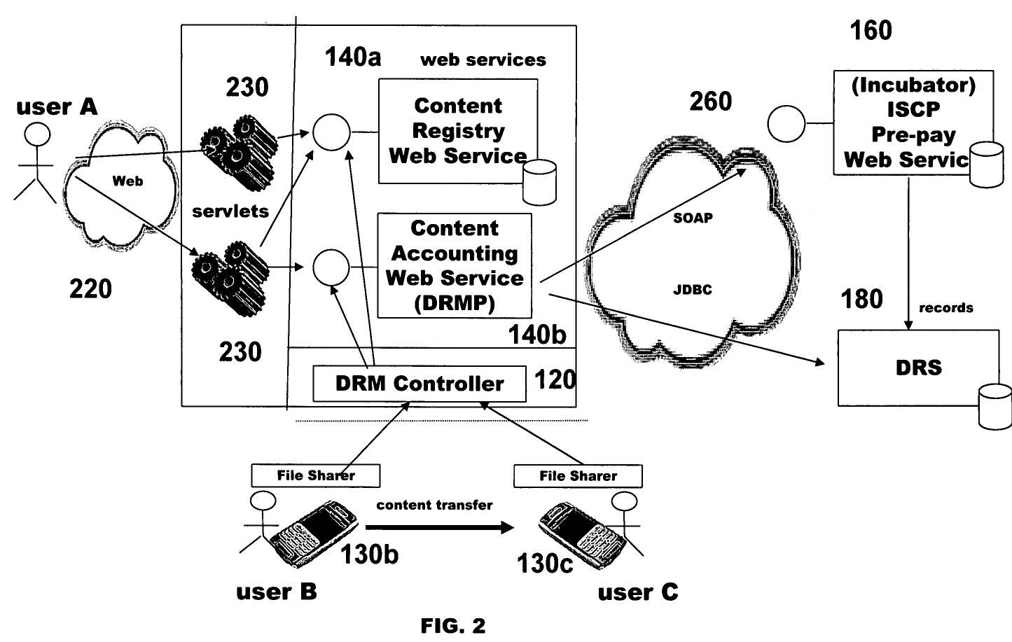

FIG. 2 depicts a more detailed embodiment of a digital content distribution system in accordance with the present invention. Again User A communicates using a device (not shown) through the Internet 220 with one or more DRM Self Service servers/servlets 230 in order to input various information about the distribution of digital content owned or controlled by User A. ACW Server 140 is broken into two components: Content Registry Web Server 140a and Content Account Web Server (DRMP) (Digital Rights Management Platform) 140b. Content Registry Web Server 140a manages the information that plays a role in allowing content to be forwarded between users. That is, it contains user or content-owner “preferences” pertaining to allowing content exchange, including, but not limited to exchange rights spelled out in traditional DRM systems. Content Accounting Web Server 140b keeps track of the amount a user desires for transfer of specific digital content and communicated through the Internet 220 using the Simple Object Access Protocol (SOAP) 260 interface with SCP Pre-Pay Server 160 to enable the account of the users and owners of content to properly decremented and incremented in accordance with the payment scheme. Content Accounting Web-Server 140b can also communicate more natively with DRS 180 and other backend payment and billing systems using Java Database Connectivity API (JDBC) allowing direct access to such information. The Content Registry Web-Server maintains only digital content metadata and not the digital content itself. The CR is a cache for encryption and decryption keys and manages policies on subscriber visibility of content. The owner of the digital content can use web server to effect file registration and de-registration

As with FIG. 1, User B and User C get permission for a transfer of digital content by communicating with DRM Controller 120. DRM Controller 120 communicated with Content Accounting Web Service 140b and Content Registry Web Server 140a. In the case of the former, DRM Controller 120 sends information about the transfer so as to enable proper incrementing and decrementing of user accounts. For example, a transfer of digital content from User B to User C could result in a decrementing of the account of User C as well as an incrementing of the accounts of User A and User B. User A, as the owner of the digital content, is likely to receive the majority of the payment made by User C but User B might also receive a small payment as a reward for being the one distributing content on behalf of User/Owner A.

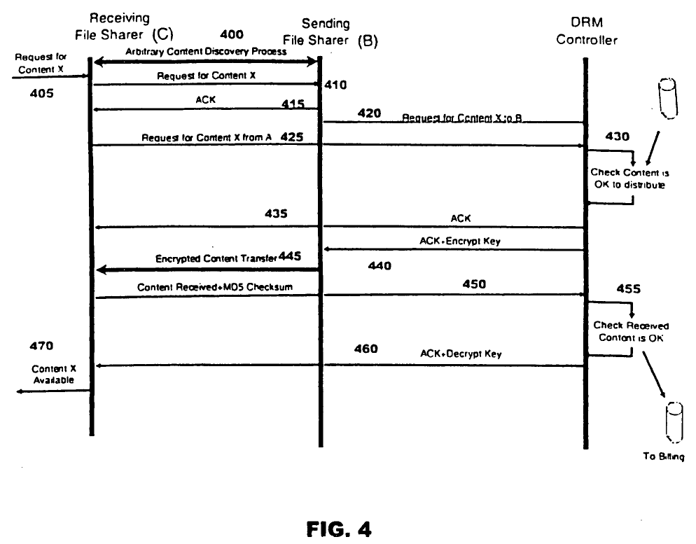

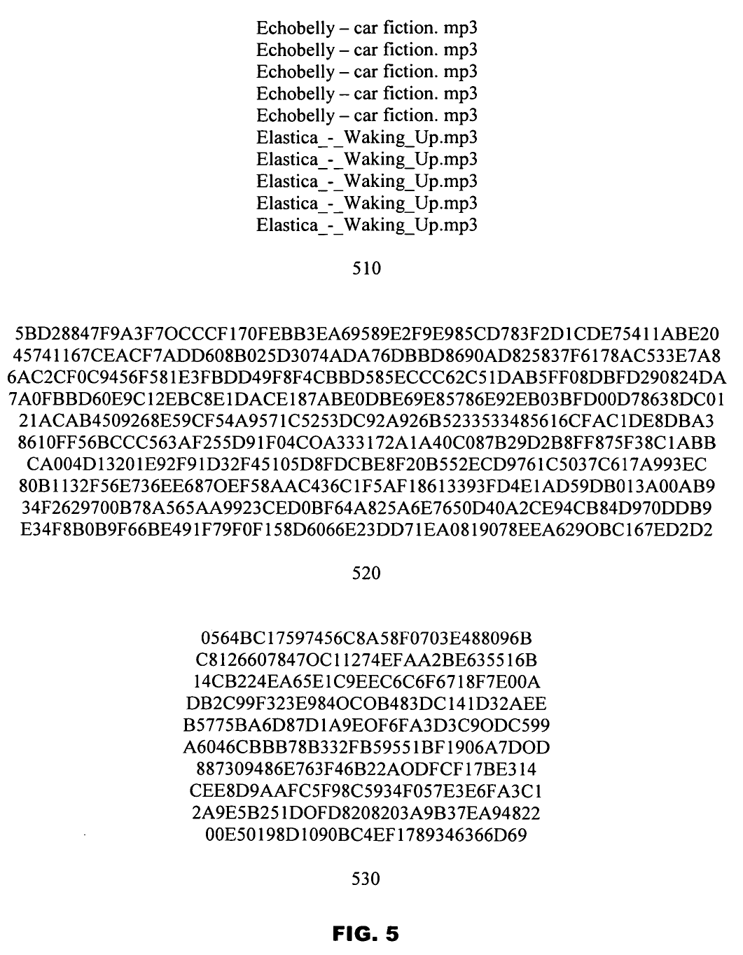

The flow of content transfer process between two users, User B and User C is shown in FIG. 4. User B and User C have previously registered with DRM controller 120 and have by some arbitary method decided that they wish to exchange a piece of digital content, X at step 400 of FIG. 4. User C requests a copy of digital content X from User B at step 405/410. User B is willing to accept the request and so sends an acknowledgement back to User C at step 415. Both User Band User C register their interest in the digital content X with the DRM Controller 120 at steps 420 and 425 respectively. Note that in the general case there may be more than one sender (i.e. equivalent to A) for a given reception. Digital content X may be any type of digital information including but not limited to digial music, movies, books, magazines, computer software, audiobooks, etc.

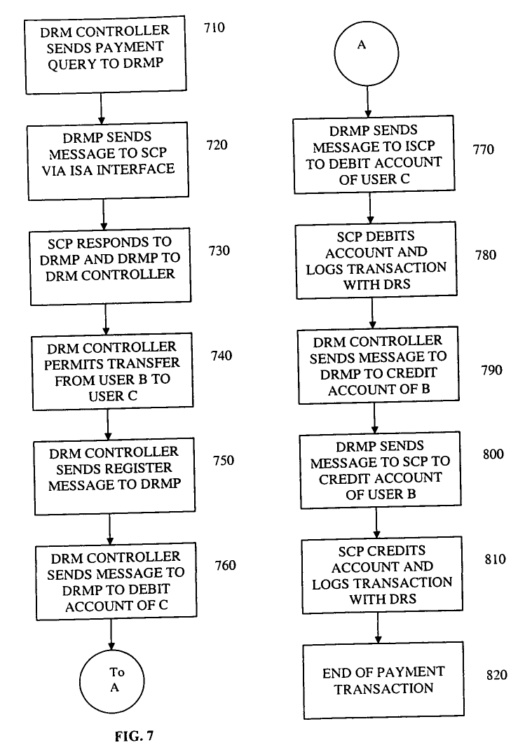

At step 430 the DRM Controller 120 performs a set of arbitary tests against the transfer request. In the payment system of the present invention the DRM Controller 120 must determine whether User Chas sufficient funds. The method of this inquiry is discussed below in connection with FIG. 7. Assuming these tests are successful, DRM Controller 120 sends an acknowledge (ACK) message back to User C at step 435 and/or an acknowledge (ACK) message with an encryption key E to User AB at step 440. This encryption key E is taken from a table of encrpytion key/hash pairs which have been provided to the DRM Controller by an external authority. For example, the encryption key/hash pairs may be provided by User A, the owner or licened distributor of digital content X. The well-known “random encrypt key” technique may be used above, which means that every content has several valid encrypt/decrypt key combos which are chosen at random on a per-transaction basis. This helps ensure security in the case that one of those pairs is compromised.

User B encrypts the content using they key provided by the DRM Controller 120. Optionally, User B also peforms a hash function (preferably but optionally MD5) over the encrypted digital content and returns this hash to the DRM Contoller 120 via arbitrary means that are well-known. These optional steps are not depicted in FIG. 4. The DRM Controller compares this hash to the one in its database. If the hash matches that in the database of the DRM Controller, the DRM Controller permits the transfer. This optional step can be used so that the DRM Controller and Users B and C are ensured that the content to be transferred between the users has not been tampered with and is exactly the content “as advertised” (a common problem in P2P networks is to receive content that has been tampered with in illicit ways).

User B then transfers the encrypted decrypts the content using the key provided by the DRM controller, making it accessible for playing or viewing on his device. Once the content transfer has completed User Censures that the received content has been physically written to non-volatile storage (to account for crashes) in a step not shown in FIG. 4. User C then calculates a hash over the encrypted form of the content E(X) and returns this hash value to the DRM Controller 120 at step 450. Because the encryption key E is not known ahead of time, User B cannot know the value of the hash a priori and can only calculate it by performing the Encryption/Hash Calculation steps. On checking the returned hash value against the hash from the table the DRM Controller 120 knows that User C does indeed have the digital content X and that the digital content is in good condition. If this value matches the value previously given then the transfer has been successful and the DRM Controller updates whatever central records are appropriate at step 455, while also returning an acknowledge (ACK) message with a decrypt key to User C to allow User C to decrypt the digital content X. A record of the transfer is kept for a period of time such that if User C crashed in the period from obtaining the complete content to receiving the decrypt key and decrypting the content then they could request said key again without incurring additional charges.

It will be noted that the DRM Controller 120 never needed to ‘see’ or possess an actual copy of the digital content. DRM Controller 120 only requires a set of encrypt key/hash pairs. If these pairs are generated by an external responsible authority then the organization running the DRM Controller need never see or have knowledge of what the digital content X is.

FIGS. 6A-E depict a set of graphical user interface (GUI) screens used by the DRM Self-Service Web Server 100 in order to gather information from the owner of digital content. Screen 610 in FIG. 6B is a user login screen for such a server. Screen 620 in FIG. 6B provides the owner/user with the ability to select the viewing of account balances, billing activity, media, and to “top-up” a pre-pay account balance. Screen 630 FIG. 6C provides information on the account balance. Screen 640 in FIG. 6D enables the user to view the digital content that he or she has transferred from another source. Screen 650 in FIG. 6E provides an interface for adding money to a pre-pay wallet for the future purchase of digital content.

The flow of messages in the payment system of the present invention is set forth in FIG. 7. Once the DRM Controller has received a request for transfer the process depicted in FIG. 7 begins. At step 710, the DRM Controller sends a payment query to the accounting and web services platform or DRMP 140 in order to determine if the pre-pay account for the user receiving the digital content, User C, has sufficient funds in his or her account. At step 720, The DRMP then sends a message to the SCP Pre-Pay Server 160 via the ISA interface forwarding the query. At step 730, the ISCP Pre-Pay Server responds to the DRMP which then informs the DRM Controller whether the funds are sufficient. Assuming the finds are sufficient, the DRM Controller permits the transfer of digital content from User B to User C at step 740 as discussed above with regard to FIG. 4. After the transfer of the digital content is deemed successful, the DRM Controller send a register message to the DRMP to record the existence of the transfer in the content registry (CR) associated with the DRMP at step 750. Then at step 760, the DRM Controller sends a message to the DRMP to debit the account of User C. At step 770, the DRMP sends a message to the SCP Pre-Pay Server requesting the debit and the SCP Pre-Pay Server debits the account of User C and logs the transaction in the DRS at step 780. At step 790, the DRM Controller sends a message to credit the account of User B, the sender in the transfer. Additionally, the account of the owner of the digital content could also be incremented in addition to the account of the sender of the digital content to the new purchaser. At step 800, the DRMP sends a message to the SCP Pre-Pay Server instructing it to credit the account. At the final step 810, the SCP Pre-Pay Server credits the account and logs the transaction with the DRS. The payment transaction ends at step 820.

In an implementation of the payment system of the present invention a Tomcat Web Application Server holds the servlets which comprise the web-portal as well as the web-services that implement some of the invention's functionality. Software written in the Java programming language has been used to implement Axis SOAP-based web services in a Tomcat container. The P2P testing application and the DRM Controller are written in Java and C. The components run on Windows and Linux. The present invention requires the introduction of a small amount of software at the file-sharing user such as User B. This client code comprises software using the Simple Object Access Protocol (SOAP) standard to communicate with the ISA. The ISA API enables implementation of the payment system with out the need to develop low-level protocol handlers.

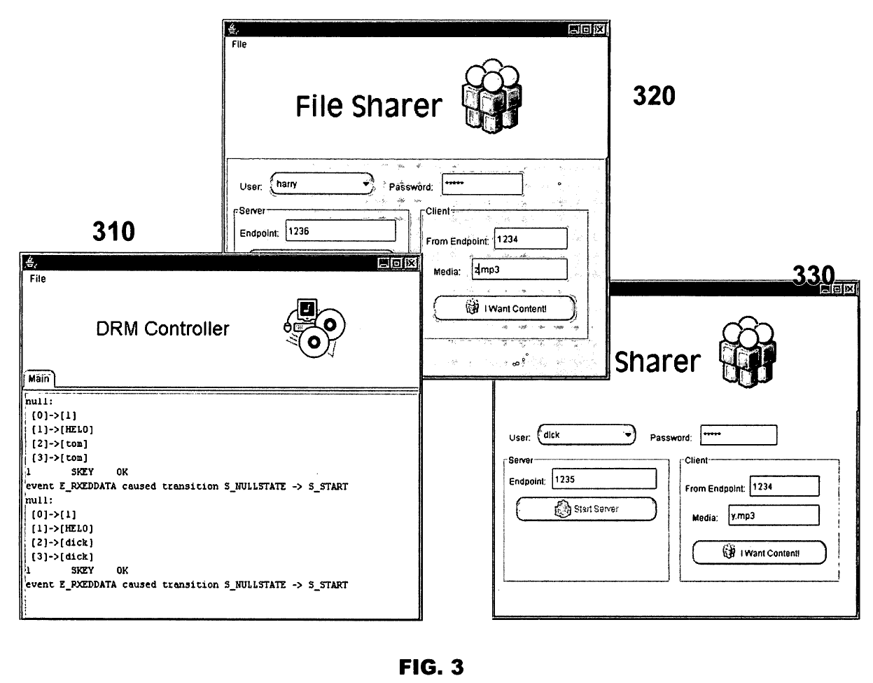

FIG. 3 depicts a few of the graphical user interface (GUI) screens shown by the DRM Controller 120 to users of the system. Interface Screen 310 is the P2P transfer control screen. Interface screen 320 is the interface seen by the receiving peer or user such as User C in the example transaction in FIGS. 1 and 2. Interface Screen 330 is the interface seen by the sending peer/user such as User B. While we developed such client screens for one embodiment nothing prevents any open source P2P client framework from being used to find content and trigger (mediated) transactions for that content (e.g. XNap is an open source client for the Napster P2P network).

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

What is claimed is:

1. A method for paying for the authorized distribution of digital content transferred from a first user to a second user both in communication with a digital rights management (DRM) controller in communication with an accounting server in communication with a services control point (SCP) wherein the SCP has access to a database containing prepay telecommunication services accounts associated with the first user and the second user comprising the steps of:
receiving at the DRM controller a request from the first user to transfer the digital content to the second user;
sending a request from the DRM controller to the accounting server to determine if the second user has sufficient funds to pay for the request;
sending a message from the accounting server to the SCP requesting information regarding the balance of the account associated with the second user;
permitting the transfer to occur if the account associated the second user has sufficient funds;
sending a message from the DRM controller to the accounting server requesting to debit the account associated with the second user;
sending a message from the accounting server to the SCP requesting to debit the account associated with the second user;
debiting the account associated with the second user at the SCP.

2. The method of claim 1 further comprising the steps of:
sending a message from the DRM controller to the accounting server requesting the crediting of the account associated with the first user;
sending a message from the accounting server to the SCP requesting to credit the account associated with the first user;
crediting the account associated with the first user at the SCP.

3. The method of claim 1 wherein the digital content is owned by a third user having an associated account in the SCP further comprising the steps of:
sending a message from the DRM controller to the accounting server requesting the crediting of the account associated with the third user;
sending a message from the accounting server to the SCP requesting to credit the account associated with the third user;
crediting the account associated with the third user at the SCP.

4. The method of claim 1 wherein the message from the first user and the second user to the DRC controller are SMS messages.

5. The method of claims 1 wherein the SCP stores information regarding the payment in data and report system (DRS).

6. The method of claim 1 further comprising the step of registering the first user and/or the second user with the DRM controller.

7. A system for paying for the authorized distribution of digital content transferred from a first user to a second user both in communication with a digital rights management (DRM) controller in communication with an accounting server in communication with a services control point (SCP) wherein the SCP has access to a database containing pre-paid telecommunication services accounts associated with the first user and the second user comprising:
a digital rights management (DRM) controller;
an accounting and content web server; and
an intelligent service control point pre-paid platform wherein the DRM controller requests information regarding the balance of the account associated with the second user in response to a request by the first user and/or second user to transfer the digital content to the second user.

8. The system of claim 7 wherein the request by the DRM controller is sent to the accounting and content web server and from the accounting and content web server to the intelligent service control point.

9. The system of claim 8 wherein the message is sent from the accounting and content web server to the intelligent service control point through the ISA API of the intelligent service control point.

10. The system of claim 7 wherein the first user and second user use pre-existing peer-to-peer client software to identify the digital content to be transferred from the first user to the second user.

11. The system of claim 7 wherein the transfer of digital content from the first user to the second user occurs through peer-to-peer client software residing with the first user and the second user.

12. The system of claim 7 wherein the intelligent service control point stores information about payment transactions in a data and report system.
